(19) United States
(12) Patent Application Publication
(10) Pub. No.: US 2026/0189677 A1
(43) Pub. Date: Jul. 2, 2026

(54) PORTABLE MULTI-CAMERA MONITORING SYSTEM AND KIT

(71) Applicant: Lextant Corporation, Columbus, OH (US)

(72) Inventors: Steven Mauger, Columbus, OH (US); Chris Rockwell, Columbus, OH (US)

(21) Appl. No.: 19/006,713

(22) Filed: Dec. 31, 2024

(51) Int. Cl. H04N 7/18; G06F 3/01; G06V 40/16; G10L 25/63; H04N 23/90

(52) U.S. Cl. CPC H04N 7/18; G06F 3/013; H04N 23/90; G06V 40/174; G10L 25/63

(57) ABSTRACT

A portable multi-camera monitoring system is disclosed, which may be in the form of a kit enabling the system to be easily transported from one environment of study to the next, for audio/video monitoring a selected environment, such as the environment of a cabin of a motor vehicle, to gather audio/video images of a user of said environment, to facilitate the subsequent analysis of audio/video data stored by said system, to guide a manufacturer on areas of said environment that have positive or negative feedback from the user, for subsequent design improvement of the subject environment.

### CROSS-REFERENCE TO RELATED APPLICATIONS

This application is filed as original and makes no priority claim.

### TECHNICAL FIELD

The present invention relates generally to camera monitoring, and more particularly to a portable, multi-camera monitoring system and kit, equipped to observe human interactions with various user interfaces in a selected environment and enable data collection therefrom.

### BACKGROUND AND SUMMARY OF THE INVENTION

It has been known to use cameras to observe selected areas of interest within viewing range of the cameras. For example, several different commercially available security systems use one or more cameras as part of their active monitoring of property. Also, it has been known to store video, still images, and audio in a digital database, for later viewing to analyze events in an area being observed. Certain techniques have been developed to understand how users operate interfaces, what they like, what they do not like, what works well, what does not work well, and the like. Typically, these techniques involve interviewing users who provide feedback, which is then utilized by designers or other individuals to improve the interface. Such techniques have a number of shortcomings, including requiring bringing participants into a laboratory or other observation environment, subjective user interpretation of feedback, and lack of real time feedback or analysis. As another example, user feedback is typically given some time after interacting with the interface, which brings issues of memory recall, hindsight bias, and the like. Even if given in real-time, users are then mentally divided between operating the interface and providing feedback, which can bring issues of feedback quality.

Marketing analysis firms have been known to observe people as they interact with things (such as commercial products or product prototypes) in order to advise manufacturers on preferred (or unpreferred) features or qualities of the things being studied. It has also been known to observe users in a selected environment, such as inside a cabin of an automobile, or while participating in a localized activity, to determine how they interact with various interfaces inside the cabin or how they perform in an activity. For example, for many years football coaches have used video camera monitoring to film and store video data to later analyze and determine how certain players perform during a football game.

The present invention is particularly useful in observing and analyzing occupant(s) of a motor vehicle, to film and store, and/or livestream, video and audio data of the occupant(s) interacting with various user interfaces inside the vehicle as they naturally occur, capturing authentic behavioral responses. The invention provides data to improve product design and user experiences with those products. For example, an occupant may interact with the vehicle radio/stereo system, and/or the vehicle's HVAC system, and/or the vehicle's dashboard display system, and/or the vehicle's mirror(s), and/or the vehicle's safety systems, and/or the vehicle's drive system, etc. Vehicle manufacturers may use the results of the analysis of the audio and video data collected, to improve their vehicles' design(s), such as in the areas of ergonomics and safety. Portable cameras may be removably and adjustably mounted within a study environment. However, the system of the present invention may be used with other devices and environments besides automobiles.

A unique aspect of the present invention is that it preferably comprises a portable kit, of one or more manually transportable containers (such as one or more latch-able hardshell briefcases or suitcases), for containing a plurality of cameras and camera mounting hardware to be mounted at various vantage points inside a vehicle, associated cabling and connectors, at least one audio microphone to capture user voice outputs, and data capture/transmission/storage components/subassemblies for audio and video data collected during a monitoring session. The kit is advantageous in that it can be readily moved from one vehicle to the next to provide a more efficient manner in which to survey multiple vehicles without the need to develop a new system for each vehicle. The cameras may be mounted to view the interface(s), participant interaction with the interface(s), participant expressions and/or eye gaze, and/or an ambient environment. Microphones may be placed within the study environment to record verbalized participant expressions. An eye gaze tracking device, which may be one of the cameras or a separate device, such as glasses, may be utilized and/or worn by the participant. The system may further include an eye-tracking module, which monitors a user's eye movements during an observation session. Such eye tracking (which may or may not be combined with facial expression analysis) may comprise data on eye concentration on a given interface for a measured period of time, which may indicate that the interface is too complicated for the user to quickly understand (a negative inference as to that interface), or may indicate that it is attractive to the user's eye (a positive inference that the interface is attractive or desirable to the user). The eye tracking module may further comprise data collection on which objects in the vehicle receive direct eye attention and which do not. The eye tracking module may further comprise data collection regarding vehicle safety. For example, is the driver's attention while driving diverted to things that are not safe for vehicle operation? Eye-tracking data may highlight areas of high engagement or distraction, helping to identify potential design flaws or safety risks. Data from the cameras, microphones, eye gaze tracking devices, and optionally the interface(s), maybe streamed simultaneously in real time to enable a holistic view of user interactions, capturing a nuanced picture of user experience and behavior. Further collection of vehicle buss data such as GPS data, speed and/or accelerometer data, hard-braking incidents, lane exceedance, active driver management system data, along with the previously described operator data, provides even greater information on driver attention/distraction and workload behavior in space and time. The data may be received at a data synthesizer for combination and/or reformatting before being passed to a data streaming device for transmission to a remote server for storage and processing, or for real-time streaming. A power supply and cooling fans may be provided for such components. The removability and portability of these components, some or all of which may fit within a portable carrying case, may allow the system to be quickly used in many different environments, including moving vehicles, remote locations, target demographic zones, laboratory environments, and/or may permit remote viewing and/or operation of the same. In this fashion, participants may be observed as they interact with devices in the real world. This may also permit the system to be used in remote environments, such as without a dedicated technologist accompanying users. The multiple cameras provide the ability to monitor the user from different vantage points inside the vehicle. For example, an uncomfortable seat that causes the driver to frequently shift seating positions while driving can be dangerous. A multi-camera system may be adapted to observe shifting in driver seat position over a measured time period of operating the vehicle. Once video, audio, and/or still image data is collected it may be stored in one or more databases for later analysis. Real time analysis of multi-camera video images, with or without concurrent audio, is also available with the present invention. For example, a 4-camera system may show each of the views from each of the 4 cameras simultaneously on a viewing display. As one example of this simultaneous viewing capability, a first camera image may be shown in an upper left corner of a display, a second camera image may be shown in the upper right corner of a display, a third camera image may be shown in a lower left corner of the display, and a fourth camera image may be shown in a lower right corner of the display. Participant audio may be played at the same time. Eye-tracking data from an eye-tracking module may be obtained and shown as well, separately or concurrently. Eye-tracking may capture the user's focus, such as checking mirrors, reading dashboard displays, or observing other vehicles or pedestrians. For example, driver focus for too long of a period of time on a display may indicate the need for a voice-activated system instead. Driver reaction times may also be measured.

A computer server may be configured to receive, reformat, and/or analyze the data. In exemplary embodiments, the server may be configured to automatically detect participant emotional state through electronic analysis of facial expressions provided in captured images from the cameras and/or voice pattern recognition of audio captured by the microphones. The server may be configured to automatically transcribe received audio with text-to-speech techniques. The server may be configured to automatically detect participant gaze location and dwell times from images from the cameras of the participant face and/or the gaze tracking devices. Software may be used to analyze the collected video images, with or without audio data. For example, if a user appears from the images to be distracted by prolonged attention to a particular user interface in the cabin of the vehicle, the software may be adapted to alert the manufacturer to the prolonged attention and suggest a change to make the interface less burdensome for the user. Or, if the video images reveal an unpleasant expression on a user's face when interacting with a particular user interface the software may alert the manufacturer to the expression(s) and the particular user interface that caused the expression(s), in order to provide the manufacturer with an opportunity to make design changes. Likewise, the software may be adapted to listen for auditory clues (i.e., certain words or expressions) that indicate a user's satisfaction with, or disappointment with, a given interface in the vehicle. For example, if the software detects the word “cool” it may mean the user likes a particular interface, in which instance the software would alert the manufacturer to the pleasurable experience the user had along with identifying which interface the user was using when the vocal expression was made. Further, the software may be adapted to detect certain derogatory terms or expressions which indicate a user's displeasure with a particular interface. In this instance the software may alert the manufacturer to the user's particular displeasure, which may result in design changes to improve the user's experience with that interface. The software may be adapted to recognize user trends and to identify patterns of user behavior (such as common distractions, usability issues, or safety concerns) in the environment being studied. For example, if the present invention identifies that user's often overlook warnings on a vehicle display, designers can adjust the display design to be more attention-grabbing. The software may be adapted to integrate with other sensory devices that may be incorporated into the present invention, such as user heart rate detector, facial expression detector, and other biometric detectors. A driver's heart rate increase when interacting with a particular feature in the vehicle may indicate the feature is too complicated and stressful. The present invention is helpful in designing driver-assistance systems or fully autonomous vehicles.

The server may be configured to automatically correlate such information with interactions at the interface(s), such as based on data received from the interfaces and/or machine vision analysis of images from the cameras. Graphical output may be generated with the correlated information. The graphical output may include graphs, charts, and the like and/or suggested updates to the device, such as where the correlated data is outside acceptable standards. The graphical output may include images from the cameras overlaid with participant eye gaze indicators, transcribed audio, indications of interactions at the interfaces, combinations thereof, or the like. This information may be used to improve the devices under study over time, such as vehicles, consumer electronics, appliances, and the like.

Further features and advantages of the system and kit disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is simplified plan view of an exemplary system in accordance with the present invention;

FIG. 2 is a flow chart with exemplary logic for operating the system of FIG. 1;

FIG. 3 is a perspective view of a portion of the system of FIG. 1 in an exemplary application;

FIG. 4 is another perspective view of a different portion of the system of FIG. 1 in the exemplary application;

FIG. 5 is another perspective view of a different portion of the system of FIG. 1 in the exemplary application;

FIG. 6 is another perspective view of a different portion of the system of FIG. 1 in the exemplary application;

FIG. 7 is a series of views of exemplary output from the system of FIG. 1 for the exemplary application of FIGS. 4-6;

FIG. 8A is a graphical view of other exemplary output of the system of FIG. 1 for the exemplary application of FIGS. 4-6;

FIG. 8B is another graphical view of other exemplary output of the system of FIG. 1 for the exemplary application of FIGS. 4-6;

FIG. 8C is another graphical view of other exemplary output of the system of FIG. 1 for the exemplary application of FIGS. 4-6;

FIG. 8D is another graphical view of other exemplary output of the system of FIG. 1 for the exemplary application of FIGS. 4-6;

FIG. 8E is a chart view of other exemplary output of the system of FIG. 1 for the exemplary application of FIGS. 4-6;

FIG. 8F is another graphical view of other exemplary output of the system of FIG. 1 for the exemplary application of FIGS. 4-6;

FIG. 9 is a perspective view (shown open) of an exemplary, manually portable container containing cabling and connectors of the kit of the present invention; and,

FIG. 10 is a perspective view, of another exemplary, manually portable container and other associated components of the kit of the present invention, in place in a vehicle.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the illustrations are to be expected. Thus, embodiments of the invention should not be construed as limited to the particular embodiments illustrated herein.

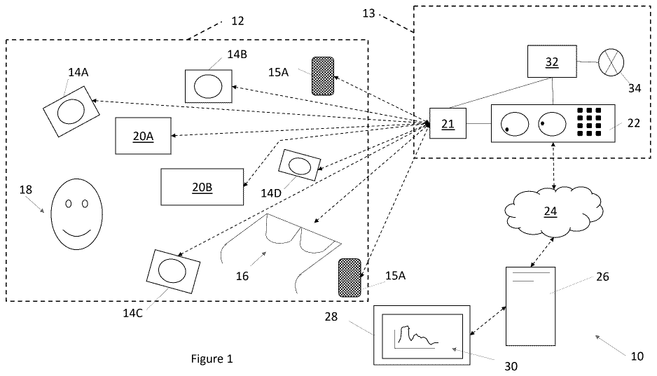

FIG. 1 illustrates an exemplary system 10 for monitoring interface environments. The system 10 may comprise one or more cameras 14A-D. Preferably, at least one camera 14A is positioned to view a participant 18, another camera 14B is positioned to view a primary interface 20A, a third camera 14C is positioned to view a surrounding environment, and a fourth camera 14D is positioned to view a secondary interface 20B. Other types, kinds, numbers, and/or arrangements of cameras 14 may be utilized. In exemplary embodiments, without limitation, the camera(s) 14 are each mounted to one or more fixed points of a device 12 under study. Such mounting may be made by way of one or more intermediary devices such as arms, joints, holders, combinations thereof, or the like. Multi-lens and/or “360” cameras may be used to provide the multiple cameras 14 or views thereof. Examples include, without limitation, suction cup mounted articulating arms, and/or articulating arms configured to attach to headrests or other locations in the vehicle.

The system 10 may comprise one or more gaze tracking devices 16, such as to track eye gaze of the participant 18. The gaze tracking devices 16 are preferably provided as part of glasses or other eyewear and/or participant 18 facing camera(s) 14A. Any number or type of gaze tracking devices 16 may be utilized.

The system 10 may comprise one or more microphones 15, such as for receiving audio from the participant 18. Preferably, at least two microphones 15A, 15B are utilized to provide binary audio, though other number, type, and arrangement of microphones 15 may be utilized.

The devices 12 may comprise vehicles, appliances, consumer goods, electronics, combinations thereof, or the like. The devices 12 may have one or more types of interfaces 20. The interfaces 20 may comprise touch screens, knobs, switches, dials, gauges, electronic displays, combinations thereof, or the like.

The camera(s) 14, gaze tracking device(s) 16, microphone(s) 15A, and optionally the interface(s) 20, may be in electronic communication with a data synthesizer 21. The data synthesizer 21 may be in wired and/or wireless electronic communication with each such component. The data synthesizer 21 may receive input from each of the components and combine them, such as into a common data output. For example, without limitation, the data synthesizer 21 may comprise a multiplexer. Alternatively, or additionally, the data synthesizer 21 may be configured to reformat incoming data into a common and/or compatible format, such as for the common data output.

The system 10 may comprise a data streaming subsystem 22. The data streaming subsystem 22 may be in wired and/or wireless electronic communication with the data synthesizer 21. The data streaming subsystem 22 may be configured to synthesize and/or process the data and/or further synthesize and/or process the data, such as into a common and/or compatible format, received though such is not necessarily required. The data streaming subsystem 22 may be configured to electronically and wirelessly stream the data to one or more computer servers 26, such as by way of one or more computer networks 24. The servers 26 may be configured to store the received data. The data streaming subsystem 22 may be configured to scale video quality up and/or down.

The data synthesizer 21 and/or the data streaming subsystem 22 may be configured to combine and/or process audio from multiple microphones 15 and/or video from multiple cameras 14.

The data synthesizer 21 and/or the data streaming subsystem 22 may comprise a monitor and/or display to confirm or view the operation of the system, such as the various data input and/or outputs.

One or more of the interfaces 20 may comprise a touch interface, display, or the like (e.g., computer screen). The data synthesizer 21 and/or the data streaming subsystem 22 may be configured to receive data from the interfaces 20, including but not limited to a screen mirror of the displayed information.

The data synthesizer 21, data streaming subsystem 22, microphone(s) 15, camera(s) 14, interface(s) 20, and/or gaze tracking devices 16 may be electrically connected to one or more power sources 32. The power source(s) 32 may be separate from, or part of, the devices 12. For example, without limitation, the power source(s) 32 may comprise batteries for a vehicle or separate, dedicated batteries. For portable applications, by way of example, two 100 Ah deep cycle batteries may be provided with a power cable to a dual connection box to facilitate hot swapping. For more stationary applications, by way of example, a 30A 12V power supply may be utilized. Other numbers, types, and/or arrangements of power source(s) 32 may be provided.

One or more cooling fans 34 may optionally be provided for cooling some or all of the data synthesizer 21, data streaming subsystem 22, microphone(s) 15, camera(s) 14, interface(s) 20, and/or gaze tracking device(s) 16 which are electrically connected to, and powered by, the power source(s) 32. For example, without limitation, four cooling fans 34 with a single exhaust point may be provided.

In exemplary embodiments, some or all components of the system 10 may be portable. For example, without limitation, the camera(s) 14 and microphone(s) 15 may be removably mounted to the device 12, such as by way of adjustable arms or the like. The gaze tracking devices 16 may be removeable. Alternatively, or additionally, the data synthesizer 21, data streaming subsystem 22, power supply 32, and/or cooling fan 34 may be removable mounted to the device 12. For example, without limitation, some or all of these components, or others, may be placed in a portable storage container 13, though such is not required. The portable storage container 13 may be positioned at the device 12 (e.g., placed in the trunk of a car) or separate therefrom (e.g., adjacent an appliance). The server 26 may be remote from the device 12.

In exemplary embodiments, some or all components of the system 10 may be operable by a single user interface, such as at the data streaming subsystem 22 or separate therefrom. In this way, a single power and/or record button may be actuated to start operations.

Bundled and/or harnessed wiring may be utilized to connect the data synthesizer 21 and/or the data streaming subsystem 22 to the various components of the system 10, such as the cameras 14, microphones 15, interfaces 20, combinations thereof, or the like.

The system 10 may be configured to track participant 18 emotions and/or behaviors. For example, without limitation, the participant facing camera(s) 14A may capture images of the participant's face and/or gesticulations or other movements. Alternatively, or additionally, the microphone(s) 15 may capture participant 18 verbalized expressions or other sounds. The server(s) 26 may comprise and utilize one or more analytical subsystems, such as facial recognition technology, machine vision technology, and/or audio analysis technology to predict participant emotions from facial expressions, gesticulations, movements (e.g., shifting, standing, arm position, body language, etc.), tone of voice, vocal stress pattern recognition, and/or verbalized expressions.

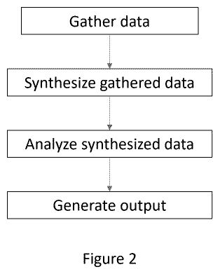

Referring additionally to FIG. 2, data from the various components of the system 10 (e.g., camera(s) 14, microphone(s) 15, gaze tracking device(s) 16) may be synthesized at the data synthesizer 21 and/or the data streaming subsystem 22. The data may be analyzed at the data streaming subsystem 22 and/or the server 26. Graphical output 30 may be generated based on the analyzed data, such as by way of the server 26, at one or more user device 28. The user devices 28 may be remote from the device 12 and/or servers 26.

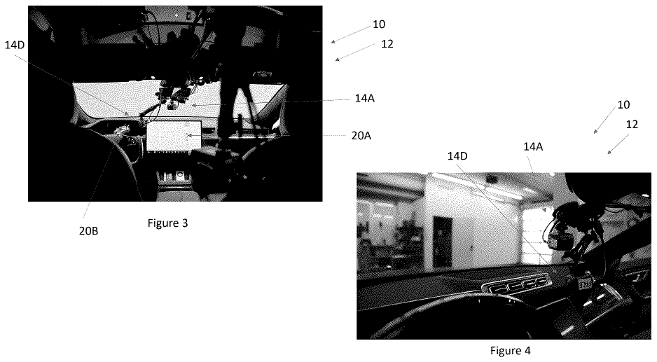

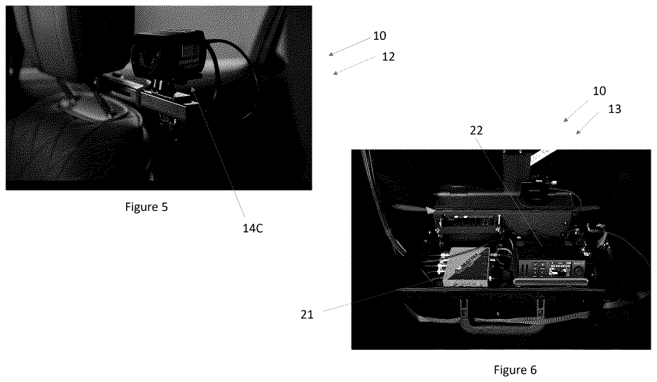

FIG. 3 through FIG. 6 illustrate components of the system installed in an exemplary device 12, which in the illustrated example is a vehicle, in an exemplary fashion. The interfaces 20 in the illustrated example includes a touchscreen 20A and a dashboard display 20B (e.g., speedometer, tachometer, fuel gage, oil pressure gage, vehicle status indicators, headlight indicators, turn signal indicators, combinations thereof, or the like) and/or steering wheel. The illustrated example is not intended to be limiting. The system 10 may be used with a number of devices 12 having interfaces 20, such as appliance (e.g., washers, dryers, refrigerators, etc.), electronics (e.g., computers, smart phones, tablets, etc.), toys, consumer products, combinations thereof, or the like.

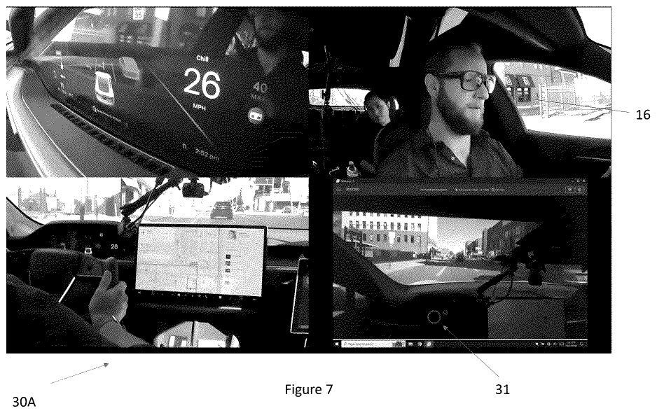

FIG. 7 illustrates an exemplary graphical output 30A from the server 26 and/or the data streaming subsystem 22 for the exemplary application of FIGS. 3-6. The illustrated graphical output 30A may comprise video captured by the cameras 14. The server 26 may be configured to automatically and graphically identify eye gaze visually with an eye gaze indicator 31. The server 26, by way of non-limiting example, may do so by way of data from the gaze tracking devices 16 and/or camera(s) 14 facing the participant 18. The graphical output 30A may be provided at the one or more user devices 28 such as for user or third-party observation.

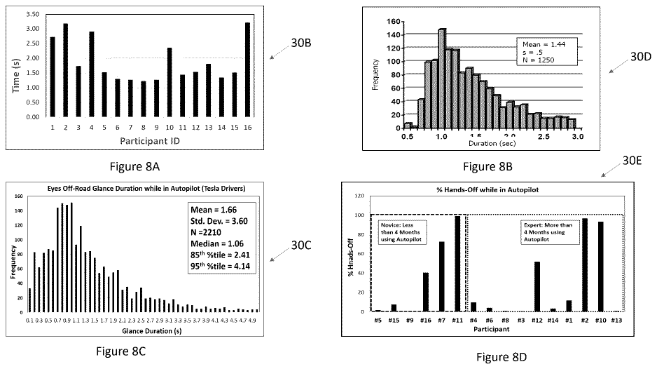

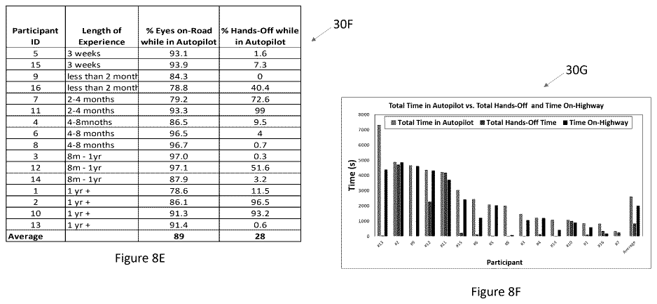

FIG. 8A through FIG. 8F illustrates other exemplary graphical output 30B-30G from the server 26 and/or the data streaming subsystem 22 for the exemplary application of FIGS. 3-6. The server 26 may be configured to automatically and electronically determine various data points from the data input including instances of looking towards and/or away from an interface 20 (e.g., duration, frequency, location, combinations thereof, or the like), instances of looking towards and/or away from an ambient environment (e.g., duration, frequency, location, combinations thereof, or the like), interface 20 engagements, participant expressions, participant emotional states, participant verbalized feedback, combinations thereof, or the like. For example, without limitation, the data may include looking at or away from a road, undertaking certain tasks at the interfaces 20 (e.g., adjusting audio, navigation, steering wheel, etc.), combinations thereof, or the like.

In exemplary embodiment, without limitation, the system 10 may receive at least some of this data from the interfaces 20, such as when certain user input is received or certain operating modes are engaged (e.g., when an automated driving mode is engaged, when certain actions are performed at the interfaces 20, etc.). Alternatively, or additionally, such data may be obtained by use of machine vision software processing images of the interfaces 20 and/or the participant 18. Alternatively, or additionally, the system 10 may receive data from the gaze tracking devices 16 regarding participant 18 eye gaze.

The system 10 may, alternatively or additionally, include touch sensors and/or receive data from the interfaces 20 and/or one or more touch sensors regarding participant 18 touch of various interfaces 20 (e.g., hands on steering wheel, interaction with radio, locations touched, touch frequency, etc.).

The data received may be automatically synthesized and analyzed to make certain determinations and/or obtain the graphical output 30. The graphical output 30 may comprise one or more suggested updates to the devices 12, interfaces 20, operating modes, or the like. The servers 26 may be configured to automatically highlight certain datapoints, such as data above or below certain predetermined acceptable criteria (e.g., thresholds, floor, ceiling, ranges, etc.). Such highlighted datapoints may be provided in the graphical output 30 by way of non-limiting example. For example, without limitation, such criteria may involve off road eye gaze above a certain duration, frequency, correlation with automated safety features engaged, combinations thereof, or the like. The criteria may vary based on the nature of the study, the device 12 under study, user preferences, or the like.

In exemplary embodiment, without limitation, the system 10 may receive data from the cameras 14 and/or microphones 15 regarding participant 18 behaviors (e.g., happy, excited, upset, frustrated, angry, etc.) For example, without limitation, automated facial recognition technology, machine vision technology (e.g., body language, facial expressions, etc.), and/or audio analysis technology (e.g., voice pattern recognition, keyword searching, etc.) may be employed to analyze camera 14 feed and/or audio feed from the microphones 15 to determine participant 18 emotional state. The server 26 may correlate participant emotional state or behavior with interactions at the interface 20 and/or operational state of the device 12.

Such information may be included in the graphical output 30, particularly as correlated with various participant 18 interactions with the interfaces 20 (e.g., user more relaxed when using automated driving modes, frustrated when attempting to operate a given function of the interface, etc.). This may assist with automated identification of particular features, operations, or the like of the interfaces 20 and/or devices 12 which should be targeted for improvement. For example, without limitation, where a frequency of particular participant behaviors 18 are detected from data inputs when performing a specific task, interacting with a particular area of the interfaces 20, combinations thereof, or the like, those features, areas, or the like may be automatically identified at the graphical output 30 as target improvement point.

Audio feedback from the participants 18 regarding interactions, thoughts, comments, or the like may be automatically transcribed using speed to text software and generated into an electronic transcript. The electronic transcript may be automatically and electronically correlated with accompanying images from one or more of the cameras 14, tasks requested, interface 20 and/or device 12 operational state, combinations thereof, or the like. In this way, a user may be presented, such as by way of graphical output 30 at the user devices 28, the user feedback along with images or other data indicating the participant 18 tasking, interaction with interfaces 20, device 12 operational state, combinations thereof, or the like, in a correlated fashion. In exemplary embodiments, the electronic transcript may be displayed simultaneously with such images or other data.

The type and kind of data received, analysis undertaken, and graphical output 30 generated may be device 12 specific and may be adjusted automatically and/or by user preference.

The system 10 may utilize one or more machine learning techniques. In exemplary embodiments, without limitation, the server 26 may comprise machine learning software for determining participant 18 emotional state, transcribing audio, determining interface interactions, determining eye location, combinations thereof, or the like. The data determined in this regard may be manually reviewed by users, such as at the graphical output 30 having the various datapoints, and provided to the machine learning software as validation or retraining input. The software may be trained, retrained, and optimized in this regard to improve results over time.

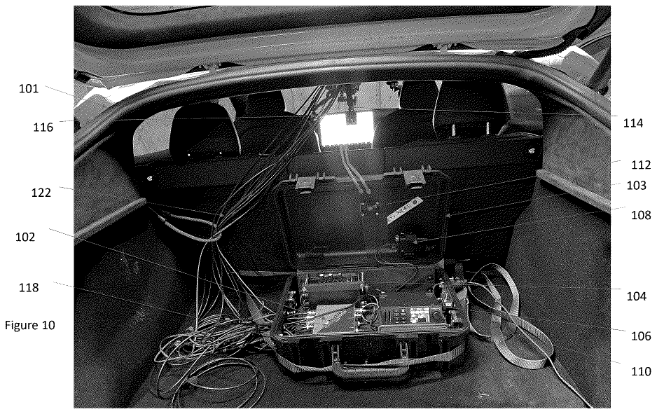

An exemplary embodiment of the present invention will now be described in greater detail, and may be configured in a vehicle 101 as shown in FIG. 10. This embodiment may include a first container 103 of the present invention, placed in the vehicle 101. This exemplary embodiment is all SDI with four inputs into an AV Matrix MV0430 (or a Decimator Dmon 6) quad processor 102. The quad has 3 outputs, two SDI and one HDMI. SDI 1 goes to an audio embedder where it gets audio from an Azden FMX-22 field mixer 104. Audio+Video then goes to a Black Magic HyperDeck Mini 106 for recording. The HyperDeck records to an AngelBird SD card 108.

Under the quad is a multi-purpose Decimator MDHX. Its intended purpose is to capture a screen mirror for computer-based studies, to duplicate and return the HDMI signal while creating an SDI feed for the quad. A second use is to provide an observation room for clients, to send the SDI out via this component. On the end the signal is converted to HDMI with a Decimator MDLX.

A small monitor may be used to confirm video and audio. For camera setup the second HDMI out from the quad is used and run to a Lilliput FS7 with battery to give a view for camera aiming and a small preview near the team if needed.

The power in this case may be a distribution center under the recorder. All devices may be powered from here as well as power plugs for the 4 cameras that plug into the quad. Custom length power cables plug to the invention and travel with the SDI to either a Marshall CV-506 or a CV355-10X.

Power supply is dependent on the project. If the present invention is being placed in cars that are driving around town, two 100 Ah deep cycle batteries may be placed in the trunk connected to a custom cable from a dual connection box (to enable hot-swap batteries) and plug into the system. If it's a lab-based study, to provide power a small SKB case that houses a MeanWell 30A 12V power supply that may use the same custom cable is preferred.

The system, as well as the power supply, may be cooled by Noctua cooling fans 110. Four fans are preferred, plus one exhaust fan 112 with an inlet hole.

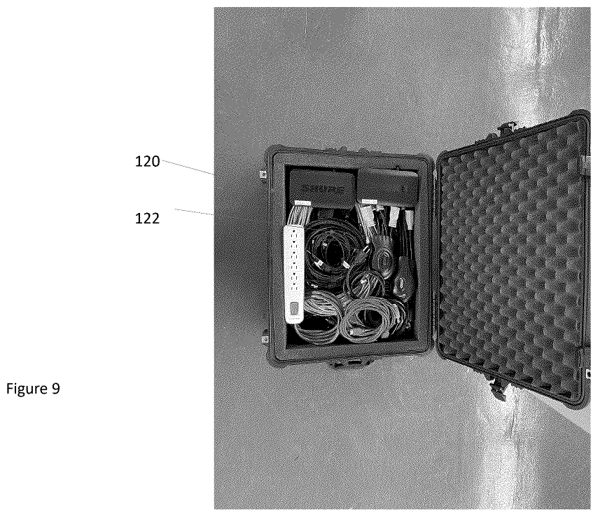

In this preferred embodiment of the present invention, the user has to hook up 8 cables (4 SDI, and 4 power) and the power supply to get the system operational, and only has to push one button to start recording. A Teradek Prism may be added on the SDI out from the HyperDeck for data streaming. The Prism may encode to a channel on a cloud video service for secure, reliable, mobile streaming. FIG. 9 shows a container 120 for holding cabling 122 for use with the present invention.

One or more microphones may be placed in the vehicle 101, such as clipped onto a sun visor of the vehicle. A ceiling mounted camera 114, may be placed over the shoulder of the driver of the vehicle 101, to capture driver activity (such as head and hand movements) with respect to the vehicle interface(s), and to capture another view of the vehicle dashboard display area. A second camera may be placed at or near the dashboard to focus on the vehicle dashboard display as it changes during vehicle operation. A third camera 116 may be mounted to the top center of the vehicle windshield to capture driver movements and facial expressions. A fourth camera may also be secured to the windshield (such as by suction cups), and may capture eye gaze of the driver and times of eye dwelling on particular areas of the vehicle interfaces. In the container 118 is shown the video recorder 106, processor 102, and audio mixer 104. Also included is a one terabyte hard drive 108 for receiving the data captured.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention.

Certain operations described herein may be performed by one or more electronic devices. Each electronic device may comprise one or more processors, electronic storage devices, executable software instructions, combinations thereof, and the like configured to perform the operations described herein. The electronic devices may be general purpose computers or specialized computing devices. The electronic devices may comprise personal computers, smartphone, tablets, databases, servers, or the like. The electronic connections and transmissions described herein may be accomplished by wired or wireless means. The computerized hardware, software, components, systems, steps, methods, and/or processes described herein may serve to improve the speed of the computerized hardware, software, systems, steps, methods, and/or processes described herein. The electronic devices, including but not necessarily limited to the electronic storage devices, databases, controllers, or the like, may comprise and/or be configured to hold, solely non-transitory signals.

What is claimed is:

1. A system for monitoring interface environments, said system comprising:
a plurality of cameras each camera adapted to be removably secured in different locations about a device environment to capture image data of the environment, said device having one or more interfaces, said one or more interfaces controlling operations of the device and/or indicating operational status of the device;
a gaze tracking device;
a data synthesizer in electronic communication with the plurality of cameras and the gaze tracking device;
a data streaming subsystem in electronic communication with the data synthesizer;
a server in electronic communication with the data streaming subsystem, wherein the server is configured to:
receive synthesized data from the data streaming subsystem;
automatically identify, from the synthesized data, participant eye gaze location and dwell times;
automatically correlate, from the synthesized data, the eye gaze location and dwell times with operations at the interface; and
generate data sufficient to create graphical output at one or more remote user devices indicating the correlated data.

2. The system of claim 1 wherein:
a first one of the plurality of cameras is arranged to view an operator of the device;
a second one of the plurality of cameras is arranged to view at least one of said one or more interfaces.

3. The system of claim 2:
further comprising:
at least one microphone in electronic communication with the data synthesizer; and
a power supply electrically connected with the data synthesizer and the data streaming subsystem; and
wherein:
the gaze tracking device comprises eye glasses;
at least the data synthesizer, data streaming subsystem, and power supply are provided in a portable case; and
the plurality of cameras and the at least one microphone are removably and adjustably mounted within the interface environment.

4. The system of claim 3 wherein:
the interface environment comprises a vehicle; and,
the at least one interface comprises a dashboard display screen.

5. The system of claim 2 wherein:
the server comprises software instructions, which when executed, configure the server to analyze the synthesized data to automatically determine participant emotional state from at least images received from the first one of the plurality of the cameras using facial recognition and correlate the participant emotional state determinations with the operations at the interface.

6. The system of claim 2 wherein:
the server comprises software instructions, which when executed, configure the server to analyze the synthesized data to automatically determine participant emotional state from the audio received from the at least one microphone, using voice stress pattern recognition and correlate the participant emotional state determinations with the operations at the interface.

7. The system of claim 2 wherein:
the graphical output comprises images from a third one of the cameras overlaid with an indicator of participant gaze location.

8. The system of claim 2 wherein:
the graphical output comprises graphs, charts, or tables of the correlated data.

9. The system of claim 2 wherein:
the graphical output comprises a suggested update to the device based on certain of the correlated data outside of predetermined acceptable criteria.

10. The system of claim 2 wherein:
the primary interface is in electronic communication with the data synthesizer; and
the server comprises software instructions, which when executed, configure the server to analyze the synthesized data to automatically determine the operations of the primary interface.

11. The system of claim 2 wherein:
the server comprises software instructions, which when executed, configure the server to analyze the synthesized data to automatically determine the operations of the primary interface from at least images received from the second one of the plurality of cameras using machine vision.

12. The system of claim 2 wherein:
the server comprises software instructions, which when executed, configure the server to analyze the synthesized data to automatically transcribe the audio received from at least one of the plurality of microphones using speech-to-text and correlate the transcribed text with images from the plurality of cameras and operations at the interface.

13. The system of claim 1 wherein:
the device comprises an appliance.

14. The system of claim 2 wherein:
the graphical output comprises images from each of the plurality of cameras correlated with an indicator of the operations at the interface.

15. A monitoring system kit, comprising:
a portable carrying case for containing all of the system components;
at least three cameras simultaneously stored in said case;
at least three camera mounts stored in said case, said mounts adapted to secure said cameras in various locations inside a vehicle;
an audio microphone stored in said case;
an audio/video data storage medium stored in said case;
at least one data communication link adapted to provide digital data communications between said cameras and said storage medium, said at least one link stored in said case.

16. The system of claim 1, further comprising a data analysis software module configured to process said video data collected and identify points of interest from said video data and alert a user of said system to said points of interest along with a suggested design enhancement interpretation of said points of interest.

17. A portable system for remotely monitoring and automatically analyzing participant
interactions with vehicle interfaces, said system comprising:
a plurality of cameras removably and adjustably mounted within a passenger compartment of the vehicle, wherein:
a first camera is positioned to view the participant operating the vehicle;
a second camera is positioned to view a dashboard display of the vehicle;
a third camera is positioned to view a principal interface for the vehicle, said principal interface comprising entertainment, navigational, climate, and vehicle functionality options; and
a fourth camera is positioned to view an ambient environment;
at least one microphone mounted within the passenger compartment of the vehicle;
a gaze tracking device adapted to track the eyes of the participant while operating the vehicle;
a storage case located in the vehicle, and housing:
a data synthesizer in electronic communication with, and receiving output data from, the plurality of cameras, the at least one microphone, and the gaze tracking device and configured to combine the received data;
a data streaming subsystem in electronic communication with the data synthesizer and configured to transmit the received data;
a server in electronic communication with the data streaming subsystem, wherein the server is configured to:
receive the data from the data streaming subsystem;
analyze the data to automatically identify participant eye gaze location and dwell times;
analyze at least images from the first camera using facial recognition to determine emotional state of the participant;
analyze audio from the at least one microphone to electronically transcribe verbalized feedback from the participant;
analyze at least images from the third camera using machine vision to determine interactions by the participant with the principal interface;
analyze data received from the principal interface to determine operational state of the vehicle;
analyze the data to automatically correlate the eye gaze location and dwell times, emotional state of the participant, and verbalized feedback from the participant with the interactions by the participant with the principal interface and operational state of the vehicle; and
generate data sufficient to create graphical output at one or more remote user devices indicating the correlated data and including at least one alert about the vehicle based on the correlated data.
